(19) United States
(12) Patent Application Publication
(10) Pub. No.: US 2025/0109333 A1
(43) Pub. Date: Apr. 3, 2025

(54) Sand Stabilizer

(71) Applicant: Hygt Chemical LLC, McAllen, TX (US)

(72) Inventors: Hernan Jorge Trias, Buenos Aires (AR); Eduardo Alberto Gomez, McAllen, TX (US)

(21) Appl. No.: 18/902,348

(22) Filed: Sep. 30, 2024

Related U.S. Application Data
(60) Provisional application No. 63/541,735, filed on Sep. 29, 2023.

(51) Int. Cl. C09K 17/22; C09K 103/00; C09K 105/00

(52) U.S. Cl. CPC C09K 17/22; C09K 2103/00; C09K 2105/00

(57) ABSTRACT

A sand stabilizer may be introduced into and applied in coarse, grained soils, and soils with low fines content. When a sand stabilizer is introduced into silty soils, sandy soils, and/or gravelly soils, the soils may turn into a mass linked with the sand stabilizer. This process can be undone as well. The sand stabilizer is a water-based polymer that may be formed of a plasticizer-free aqueous dispersion based on styrene and an acrylic acid ester (approximately 40-60%), an aqueous copolymer dispersion based on styrene acrylic (approximately 20-40%), dibutyl phthalate (approximately 4-8%), butyl cellosolve (approximately 4-8%), and propanoic acid, 2-methyl-, monoester with 2,2,4-trimethyl-1,3-pentanediol (approximately 4-8%). The sand stabilizer may be applied in the compaction with water and mixed. The sand stabilizer may be sprayed over a soil surface.

### FIELD OF THE DISCLOSURE

The present disclosure generally relates to a sand stabilizer, and more particularly to a sand stabilizing product for engineering purposes.

### BACKGROUND

Sand stabilizers may be used to address problems with blowing and drifting sand that can create dangerous conditions, for example, when driving on roads and highways. Sand stabilizers also may be used to prevent slope and embankment collapses. However, currently used sand stabilization mechanisms may still require more regular maintenance and may not provide as much stability as is needed.

### SUMMARY

Embodiments of the present disclosure may provide a sand stabilizer that may be introduced into and applied in coarse, grained soils, and soils with low fines content. When a sand stabilizer is introduced into silty soils, sandy soils, and/or gravelly soils, the soils may turn into a mass linked with the sand stabilizer. This process can be undone as well in embodiments of the present disclosure. The sand stabilizer according to embodiments of the present disclosure is a water-based polymer that may be formed of a plasticizer-free aqueous dispersion based on styrene and an acrylic acid ester (approximately 40-60%), an aqueous copolymer dispersion based on styrene acrylic (approximately 20-40%), dibutyl phthalate (approximately 4-8%), butyl cellosolve (approximately 4-8%), and propanoic acid, 2-methyl-, monoester with 2,2,4-trimethyl-1,3-pentanediol (approximately 4-8%). The sand stabilizer may be applied in compaction with water and mixed in embodiments of the present disclosure. The sand stabilizer may be sprayed over a soil surface in other embodiments of the present disclosure.

### DETAILED DESCRIPTION

Embodiments of the present disclosure may provide a sand stabilizer designed for engineering purposes. The sand stabilizer according to embodiments of the present disclosure has been formulated, tested, and applied in coarse, grained soils, and soils with low fines content. When a sand stabilizer is introduced into silty soils, sandy soils, and/or gravelly soils, the soils may turn into a mass linked with the sand stabilizer. This process can be undone as well in embodiments of the present disclosure.

The sand stabilizer according to embodiments of the present disclosure is a water-based polymer that may be formed of a plasticizer-free aqueous dispersion based on styrene and an acrylic acid ester (approximately 40-60%), an aqueous copolymer dispersion based on styrene acrylic (approximately 20-40%), dibutyl phthalate (approximately 4-8%), butyl cellosolve (approximately 4-8%), and propanoic acid, 2-methyl-, monoester with 2,2,4-trimethyl-1,3-pentanediol (approximately 4-8%).

The sand stabilizer may be applied in compaction with water and mixed in embodiments of the present disclosure. The sand stabilizer may be sprayed over a soil surface in other embodiments of the present disclosure.

The sand stabilizer according to embodiments of the present disclosure may be used in road build-ups for roads, highways, site access in oil and gas sites, mining, and/or general civil engineering works. When used in connection with roads, for example, the California Bearing Ratio (CBR) values may be raised considerably; however, the improvement may depend on factors including, but not limited to, the soil condition and the amount of product used. Unconfined Compression Strength (UCS) values usually in sandy/gravelly soils are null, as the soil has no self-standing condition to develop these tests (frictional soils). In this regard, the cohesion generated by the adhesion of a sand stabilizer according to embodiments of the present disclosure may allow samples to self-stand and develop these tests, with high results as the curing process progresses.

Dust control may be required on roads, as the dust highly reduces visibility. With a sand stabilizer according to embodiments of the present disclosure, no dust may merge from the surface, as the sand stabilizer may be highly effective for keeping the particles adhered. Dust in air measurements gives low to null values in comparison with no treatment condition and complying with health, safety, and environmental (HSE) requirements.

Permeability of soils can be reduced from high permeability to “impermeable.” The waterproof effect that a sand stabilizer according to embodiments of the present disclosure may have on the soil may generate a strong adherence and make it possible to let the water flow in the top of the sand. The results of this condition may be tested and proved with lab testing and sites applications. Temporary water channels have been made in sand with this product.

Erosion of soil in roads can be a problem as well. Using a sand stabilizer according to embodiments of the present disclosure, roads in oil and gas sites may be yearly maintained instead of requiring weekly maintenance, thereby allowing more time between maintenance.

Wet/dry cycles and submerged condition of soils may be a main cause of deterioration of road build-ups. Tests have shown that a small block of sand treated with a sand stabilizer according to embodiments of the present disclosure can stand months under the water without any change. Samples for testing also have shown that after submerged condition, the values have not experienced significant changes and comply with standards in both soaked and unsoaked condition.

With respect to slopes/ravines stability and erosion, the loss of moisture in slopes and ravines may be a big issue for their stability of them. The surface water infiltrations can generate high loads and unstable conditions. The sand stabilizer according to embodiments of the present disclosure has been proved effectively to keep sand stable and to impermeabilize the surface, giving more certainty to the stability calculations slopes. Slopes and ravines in sandy soils usually experience sliding during their lifetime. The impermeability, cohesion, and strength that the sand stabilizer according to embodiments of the present disclosure may give to the soil may reduce the risk to the slides. Erosion in slopes may generate preferential channels for the water flowing from the surface. These channels turn them into highly unstable conditions that increase considerably the risk of failure of the slope and are a usual cause of sliding. There is no need to expose a slope/ravine to that risk, usually risking human life, infrastructure, and the economic growing of cities and population. Use of the sand stabilizer according to embodiments of the present disclosure in a correct engineering design that may provide a solution to this problem.

Dust in construction sites and roads is usually a problem for HSE and for road safety, as the dust can be inhaled by the people in site and visibly surrounding population, and the dust in the air generates bad visibility condition, which can be the main cause of accidents in some site environments. The sand stabilizer according to embodiments of the present disclosure has been proved in oil and gas roads in deserted locations, and the reduction of dust has been approved by the HSE managers of the site, considering it a good tool for avoiding risk for breathing and possible collisions due to the reduction visibility.

The sand stabilizer according to embodiments of the present disclosure may be used for other complex engineering solutions including, but not limited to, tunneling, drilling, waterproofing, and injection. The sand stabilizer may be applied to make “temporary” casings while drilling in sand, with use of adequate drilling techniques and tools, thereby providing a good instrument for ground engineering and drilling companies.

Tunnel leaks may be controlled using the sand stabilizer according to embodiments of the present disclosure. Using the sand stabilizer according to embodiments of the present disclosure as chemical grouting, high porosity loose soils may be turned into a more cohesive and stronger column below foundations. Surrounding areas of pipes and manholes may be impermeabilized and sealed from groundwater and/or open water channels in sand.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A sand stabilizer introduced into coarse, grained soils and soils with low fines content, the sand stabilizer comprising:
a water-based polymer formed of a plasticizer-free aqueous dispersion based on styrene and an acrylic acid ester;
an aqueous copolymer dispersion based on styrene acrylic;
dibutyl phthalate (approximately 4-8%), butyl cellosolve; and
propanoic acid, 2-methyl-, monoester with 2,2,4-trimethyl-1,3-pentanediol,
wherein when introduced, the coarse, grained soils and soils with low fines content turn into a mass linked with the sand stabilizer.

2. The sand stabilizer of claim 1 further comprising:
approximately 40-60% of the water-based polymer formed of a plasticizer-free aqueous dispersion based on styrene and an acrylic acid ester;
approximately 20-40% of the aqueous copolymer dispersion based on styrene acrylic;
approximately 4-8% of dibutyl phthalate (approximately 4-8%), butyl cellosolve; and
approximately 4-8% of propanoic acid, 2-methyl-, monoester with 2,2,4-trimethyl-1,3-pentanediol.

3. The sand stabilizer of claim 1, wherein the sand stabilizer is introduced in compaction with water and mixed.

4. The sand stabilizer of claim 1, wherein the sand stabilizer is sprayed over a surface of coarse, grained soils and soils with low fines content.

5. The sand stabilizer of claim 1, wherein permeability of coarse, grained soils and soils with low fines content having the sand stabilizer introduced is reduced from high permeability to impermeable.

6. The sand stabilizer of claim 1, wherein introduction of the sand stabilizer keeps coarse, grained soils and soils with low fines content stable and impermeabilizes a surface.

7. The sand stabilizer of claim 1, wherein the sand stabilizer acts as a chemical grouting to control tunnel leaks.

8. The sand stabilizer of claim 1, wherein surrounding areas of pipes and manholes are impermeabilized and sealed from groundwater and/or open water channels in coarse, grained soils and soils with low fines content.

9. A sand stabilizer introduced onto a surface of a road, the sand stabilizer comprising:
a water-based polymer formed of a plasticizer-free aqueous dispersion based on styrene and an acrylic acid ester;
an aqueous copolymer dispersion based on styrene acrylic;
dibutyl phthalate (approximately 4-8%), butyl cellosolve; and
propanoic acid, 2-methyl-, monoester with 2,2,4-trimethyl-1,3-pentanediol, wherein when introduced onto the surface of the road, dust particles adhere to the sand stabilizer and no dust emerges from the surface.

10. The sand stabilizer of claim 9 further comprising:
approximately 40-60% of the water-based polymer formed of a plasticizer-free aqueous dispersion based on styrene and an acrylic acid ester;
approximately 20-40% of the aqueous copolymer dispersion based on styrene acrylic;
approximately 4-8% of dibutyl phthalate (approximately 4-8%), butyl cellosolve; and
approximately 4-8% of propanoic acid, 2-methyl-, monoester with 2,2,4-trimethyl-1,3-pentanediol.

11. The sand stabilizer according to claim 9, wherein California Bearing Ratio (CBR) values increase after introduction of the sand stabilizer onto the surface of the road.

12. The sand stabilizer according to claim 9, wherein dust in air measurements in connection an area around the surface of the road provides low-to-null values following introduction of the sand stabilizer.

13. The sand stabilizer according to claim 9, wherein the road is maintainable on a yearly basis after introduction of the sand stabilizer to the surface of the road.
